(19) United States
(12) Patent Application Publication
(10) Pub. No.: US 2006/0240311 A1
(43) Pub. Date: Oct. 26, 2006

(54) Membrane-electrode unit for direct methanol fuel cells and method for the production thereof

(76) Inventor: Holger Dziallas, Ense (DE)

Correspondence Address: SMITH, GAMBRELL & RUSSELL, SUITE 3100, PROMENADE II, 1230 PEACHTREE STREET, N.E., ATLANTA, GA, 30307-3592, US

(21) Appl. No.: 10/559,152

(22) PCT Filed: Mar. 30, 2004
(86) PCT No.: PCT/EP04/03362

§ 371 Date: Apr. 26, 2006

(30) Foreign Application Priority Data
Jun. 4, 2003 (DE) 103253246

(51) Int. Cl. H01M 4/00

(52) U.S. Cl. 429/40

(57) ABSTRACT

The invention relates to a membrane electrode unit for electrochemical apparatuses, in particular for direct methanol fuel cells (DMFC) and a method for the production thereof. The multilayer MEUs for DMFC according to the invention comprise of an anode gas diffusion substrate, an anode catalyst layer, an ionomer membrane, a cathode catalyst layer and a cathode gas diffusion substrate, the anode catalyst layer being applied to the anode gas diffusion substrate, while the cathode catalyst layer is present directly on the membrane. Improved power values in combination with reduced precious metal consumption can be achieved thereby.

The invention relates to a membrane electrode unit for electrochemical apparatuses, in particular for direct methanol fuel cells (DMFC) and a method for the production thereof.

Fuel cells convert a fuel and an oxidizing agent in separate locations at two electrodes into electricity, heat and water. Hydrogen, methanol or a hydrogen-rich gas can be used as fuel, and oxygen or air as an oxidizing agent. The process of energy conversion in the fuel cell is distinguished by considerable freedom from pollutants and a particularly high efficiency. For this reason, fuel cells are becoming increasingly important for alternative drive concepts, domestic energy supply systems and portable applications.

The membrane fuel cells, for example the polymer electrolyte fuel cell (PEMFC) and the direct methanol fuel cell (DMFC), are suitable for many mobile and stationary applications, owing to their low operating temperature, their compact design and their power density.

DMFC fuel cells are (like PEM fuel cells) composed of many fuel cell units arranged in a stack. These are electrically connected in series for increasing the operating voltage.

The core of a DMFC fuel cell is the so-called Membrane Electrode Unit (MEU). The MEU consists of 5 layers: of the proton-conducting membrane (polymer electrolyte or ionomer membrane), of the two gas diffusion layers (GDLs or backings) on the membrane sides and the electrode layers present between membrane and gas diffusion substrates. It is therefore also referred to as a 5-layer MEU. One of the electrode layers is in the form of an anode for the oxidation of methanol and the second electrode layer is in the form of a cathode for the reduction of oxygen.

The polymer electrolyte membrane consists of proton-conducting polymer materials. These materials are referred to below as ionomers for short. A tetrafluoroethylene/fluorovinyl ether copolymer having sulfonic acid groups is preferably used. This material is marketed, for example, under the trade name Nafion® by DuPont. However, other, in particular fluorine-free ionomer materials, such as doped sulfonated polyetherketones or doped sulfonated or sulfinated aryl ketones or polybenzimidazoles, can also be used. Suitable ionomer materials are described by 0. Savadogo in “Journal of New Materials for Electrochemical Systems” I, 47-66 (1998). For use in DMFC fuel cells, these membranes generally require a thickness of between 30 and 200 micron.

The gas diffusion layers usually consist of carbon fiber paper, carbon fiber nonwoven or carbon fiber woven fabric and facilitate the access of the methanol to the reaction layer on the anode and the removal of the resulting water on the cathode with simultaneous good electrical conductivity. The gas diffusion layers can be rendered hydrophobic with PTFE and/or can have a compensating layer (for example of carbon black/PTFE).

In the DMFC, methanol (or an aqueous methanol solution) is converted directly into CO₂, water and electrical current. For this arrangement, the term “liquid feed” is used.

The corresponding reactions are:
Anode: CH₃OH+H₂O [symbol] CO₂+6H++6e−
Cathode: 3/2O₂+6H++6e− [symbol] 3H₂O
Total reaction: CH₃OH+3/2O₂ [symbol] CO₂+2H₂O

The electrode layers for the anode and cathode of the DMFC contain a proton-conducting polymer and electro-catalysts which catalyze the respective reaction (oxidation of methanol or reduction of oxygen). As catalytically active components, a bimetallic platinum/ruthenium catalyst is preferably used on the anode, and a platinum catalyst is preferably used on the cathode side. So-called supported catalysts in which the catalytically active platinum group metals have been applied in highly dispersed form to the surface of a conductive support material, for example carbon black, are used in the majority of cases. However, it is also possible to use Pt and PtRu powder (so-called platinum black). Typically, the total loading of precious metal in a DMFC-MEU are from about 4 to 10 mg of precious metal/cm².

The peak power densities are in the range from 100 to 500 mW/cm² (for operation at from 60 to 80° C. using dilute methanol solution).

The major challenges in the development of the DMFC fuel cell technology are
the excessively low power density to date (due to the slow reaction rate of the methanol oxidation),
the passage of the methanol through the membrane to the cathode side (“MeOH crossover”) and
the high loading of the precious metal-containing catalyst.

In general, it is therefore necessary to achieve a high power density of the DMFC in combination with a reduced precious metal loading.

U.S. Pat. No. 5,599,638 describes a liquid-feed DMFC based on an ion-conductive membrane. There, Nafion ®-impregnated gas diffusion substrates and/or electrodes are used. Typical proportions of the impregnating agent are from 2 to 10% by weight of the gas diffusion substrate. The increase in the power density achieved thereby and the reduction of the precious metal consumption are, however, still unsatisfactory.

U.S. Pat. No. 6,187,467 likewise discloses impregnation of an electrode with Nafion® for use in a DMFC. The electrocatalyst is applied subsequently to the impregnated electrode. The power density of the DMFC achieved therewith is unsatisfactory.

U.S. Pat. No. 6,221,523 describes the direct coating of an ionomer membrane with catalysts for the production of MEUs for DMFC. Both catalyst layers (the anode layer as well as the cathode layer) are in direct contact with the membrane. The gas diffusion substrates, which have no catalyst coating, are applied only subsequently. A higher power density is achieved, which is however still insufficient.

The present invention is therefore concerned with the provision of improved 5-layer membrane electrode units (MEUs) for direct methanol fuel cells (DMFC). The MEUs according to the invention have a high power density in combination with low precious metal consumption.

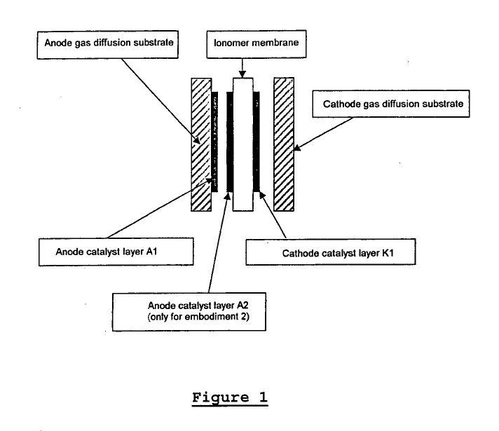

The DMFC-MEUs according to the invention comprise of the anode gas diffusion substrate, the anode catalyst layer, the ionomer membrane, the cathode catalyst layer and the cathode gas diffusion substrate and are characterized in that the anode catalyst layer is applied to the anode gas diffusion substrate, while the cathode catalyst layer is present directly on the membrane. This structure is shown in FIG. 1.

In a second embodiment, the anode layer is in the form of a so-called “double-layer anode”. This double-layer anode consists of an anode catalyst layer (A1) which is applied to the gas diffusion substrate and of an anode catalyst layer (A2) which is applied directly to the ionomer membrane, while the cathode catalyst layer (K1) is applied directly to the ionomer membrane (also see FIG. 1).

A common characteristic of the two embodiments of the invention is the presence of a cathode catalyst layer which is applied directly to the ionomer membrane, while the anode catalyst layer is applied completely or partly to the gas diffusion substrate.

This makes it possible to achieve considerable advantages since all catalyst layers can be produced independently of one another and can be tailor-made.

The catalyst layers may differ from one another. They may be made with different catalyst inks and may have different catalyst proportions and precious metal loadings (mg Pt/cm²). Different electrocatalysts (precious metal-containing or non-precious-metal-containing supported catalysts and unsupported precious metal blacks) can be used in the inks.

For example, on the anode side, the anode catalyst layer can be produced with a large layer thickness, a high catalyst loading, high porosity and better hydrophilicity, while, on the cathode side, the cathode catalyst layer can be produced so as to be as thin as possible and with good bonding to the ionomer membrane.

Typically, the layer thicknesses of the anode catalyst layer are from about 20 to 100 micron, while the cathode catalyst layers are from 5 to 50 micron. The average catalyst loadings of the MEU according to the invention are 0.25-6 mg of precious metal/cm² on the anode side and from 0.1 to 2.5 mg of precious metal/cm² on the cathode side.

Surprisingly, it has been found that improvements with regard to the power density of the DMFC can be achieved by the thin layer thickness and good membrane bonding of the cathode catalyst layer. Owing to the small layer thickness of the cathode catalyst layer, the resulting cathode water is presumably more rapidly transported away. This results in lower mass transport losses in the MEU. This in turn leads to a considerably improved power density, particularly in the high current density range. Furthermore, the oxygen diffusion in the thin cathode catalyst layer is possibly improved.

For the production of the cathode side of the MEU according to the invention, the known methods for direct coating of ionomer membranes can be used (for example from EP 1 037 295). In the embodiment of the double-layer anode (layers A1 and A2), the layer A2 is likewise produced by direct coating of the ionomer membrane.

For the production of the anode layer A1, the gas diffusion substrate (optionally rendered hydrophobic and/or coated with a microlayer) is coated with catalyst ink using known coating methods.

For the production of the MEU, both gas diffusion substrates are combined in exact register with the ionomer membrane and united with the aid of pressure and temperature, optionally with the use of sealing or adhesive material. The production of the MEUs according to the invention is also possible by continuous methods using the suitable devices. Strip-like substrates (membranes, gas diffusion substrates) are used.

The following examples are intended to explain the invention in more detail without limiting the scope of protection.

### EXAMPLE 1

### (Embodiment 1)

Production of the anode layer: A gas diffusion substrate (Sigracet type, rendered hydrophobic, with compensating layer, from SGL) is provided with an anode catalyst layer by the screen printing method. The print format is 7.5×7.5 cm (active area about 50 cm²).

Composition of the Anode Ink:

| | | |
|---|---|---|
| 18.0 | g | of PtRu supported catalyst |
| | | (60% by weight of PtRu on carbon black; |
| | | catalyst corresponding to U.S. Pat. No. 6,007,934) |
| 60.0 | g | of Nafion ® solution (15% by weight in water) |
| 12.0 | g | of water (demineralized) |
| 10.0 | g | of propylene glycol |
| 100.0 | g | |

After drying at 80° C. for 10 min, the layer thickness of the anode catalyst layer is 60 micron and the catalyst loading is 2.25 mg PtRu/cm². The catalyst-coated electrode is then washed at 80° C. in demineralized water and then dried.

Thereafter, a 125 micron thick strip-like polymer electrolyte membrane (Nafion 115®) is coated on the front with a cathode ink (process according to EP 1 037 295).

Composition of the Cathode Ink:

| | | |
|---|---|---|
| 18.0 | g | of Pt supported catalyst |
| | | (60% by weight of Pt on carbon black) |
| 60.0 | g | of Nafion ® solution |
| | | (15% by weight in propylene glycol) |
| 6.0 | g | of water (demineralized) |
| 16.0 | g | of propylene glycol |
| 100.0 | g | |

After drying at 80° C. for 10 min, the layer thickness of the cathode catalyst layer is 20 micron and the catalyst loading is 1.2 mg Pt/cm². The catalyst-coated electrode is washed in 80° C. in demineralized water.

An 8×8 cm piece having an active area of 50 cm² is cut out of the ionomer membrane coated on one side. For the production of a 5-layer MEU, the gas diffusion substrate coated with anode catalyst is then pressed with the coated ionomer membrane and a cathode gas diffusion substrate (consisting of carbon fiber paper which has been rendered hydrophobic, Sigracet type, SGL) with heat and pressure (130° C., 150 N/cm²).

The active cell area is 50 cm². In the performance tests, a 1-molar methanol solution in water is used, the methanol flow rate is 4 ml/min and the cell temperature is 60° C. Air is used as cathode gas. A very good power density is measured for this cell.

### EXAMPLE 2

### (Embodiment 2)

The production of the anode layer is effected as described in example 1. In addition to the anode layer on the gas diffusion substrate (=A1), the back of the ionomer membrane is provided with a further anode catalyst (=layer A2) after coating with the cathode catalyst (layer K1) . The application of this layer to the membrane is effected as described in example 1, but an appropriate anode catalyst ink is used.

An 8×8 cm piece having an active area of 50 cm² is cut out from the ionomer membrane coated on both sides. For the production of an MEU, the gas diffusion substrate coated with anode catalyst (layer A1) is then united, so as to coincide, with the ionomer membrane coated on both sides (layers A2 and K1) and a cathode gas diffusion substrate (consisting of carbon fiber paper which has been rendered hydrophobic, Sigracet type, SGL) and installed in a DMFC fuel cell.

The active cell area is 50 cm². In the performance tests, a 1-molar methanol solution in water is used, the methanol flow rate is 4 ml/min and the cell temperature is 60° C. Air is used as cathode gas. A very good power density is likewise measured for this cell.

1. A membrane electrode unit for direct methanol fuel cells, comprising an anode gas diffusion substrate, an anode catalyst layer, an ionomer membrane, a cathode catalyst layer and a cathode gas diffusion substrate, wherein the anode catalyst layer is applied to the anode gas diffusion substrate, and the cathode catalyst layer is present directly on the ionomer membrane.

2. The membrane electrode unit as claimed in claim 1, wherein the anode catalyst layer is applied both to the anode gas diffusion substrate and to the ionomer membrane, and the cathode catalyst layer is present directly on the membrane.

3. The membrane electrode unit as claimed in claim 1, wherein the layer thickness of the anode catalyst layer is between 20 and 200 micron and the layer thickness of the cathode catalyst layer is between 5 and 50 micron.

4. The membrane electrode unit as claimed in claim 1, wherein the precious metal loading of the anode layer is between 0.25 and 6 mg of precious metal/cm² and the precious metal loading of the cathode layer is between 0.1 and 2.5 mg of precious metal/cm².

5. The membrane electrode unit as claimed in claim 1, wherein supported or unsupported bi-metallic platinum/ruthenium catalysts are used as anode catalyst.

6. The membrane electrode unit as claimed in claim 1, wherein supported or unsupported platinum-containing catalysts are used as cathode catalyst.

7. A method for the production of a membrane electrode unit for direct methanol fuel cells, comprising
the coating of an anode gas diffusion substrate with anode catalyst ink,
the drying of the coated anode gas diffusion substrate,
the coating of an ionomer membrane on one side with cathode catalyst ink,
the drying of the ionomer membrane coated on one side and
the uniting of the coated anode gas diffusion substrate with the ionomer membrane coated on one side and the cathode gas diffusion substrate.

8. The method as claimed in claim 7, furthermore comprising the washing of the catalyst-coated gas diffusion substrates or ionomer membranes with water.

9. The use of the membrane electrode units as claimed in claim 1 for the production of direct methanol fuel cells for operation with liquid methanol/water mixtures at temperatures between 20 and 90° C.
